(19) United States
(12) Patent Application Publication
(10) Pub. No.: US 2021/0019244 A1
(43) Pub. Date: Jan. 21, 2021

(54) A Method and System for Monitoring the Status of an IT Infrastructure

(71) Applicant: AE INVESTMENT NOMINEES PTY LTD, Pyrmont, New South Wales (AU)

(72) Inventor: Ayman Eldemallawy, Pyrmont, New South Wales (AU)

(21) Appl. No.: 16/976,035

(22) PCT Filed: Feb. 26, 2019
(86) PCT No.: PCT/AU2019/050162

§ 371 Date: Aug. 26, 2020

(30) Foreign Application Priority Data
Feb. 26, 2018 (AU) 2018900604

(51) Int. Cl. G06F 11/30; G06F 11/32; G06F 11/34; G06F 11/07

(52) U.S. Cl. CPC G06F 11/3006; G06F 11/3079; G06F 11/0793; G06F 11/3476; G06F 11/321

(57) ABSTRACT

The present invention relates a method and system for monitoring the status of an IT infrastructure. Current monitoring of IT infrastructure is heavily resource intensive and many organisations employ fairly large IT teams relative to the organisation's size. In the present invention, a reference state of the infrastructure may be determined, which may be an ideal operating state of the infrastructure. The current state of the infrastructure is then tracked and compared with the reference state. If something goes wrong in the infrastructure it may be remediated by returning the state of the infrastructure to the reference state.

### FIELD OF THE INVENTION

The present invention relates to a method and system for monitoring the status of an IT infrastructure, and, particularly, but not exclusively, to a method and system for monitoring the status of an IT infrastructure and undertaking remediation or escalation.

### BACKGROUND OF THE INVENTION

Organisations are heavily reliant on continued operation of information technology (IT) infrastructure. This may include network infrastructure, service infrastructure (computer hardware and software of whatever architecture) storage infrastructure (databases, memories, etc) and other IT infrastructure. Failure or non-optimum performance of the infrastructure can (and does) deleteriously affect the organisation.

The monitoring of IT infrastructure is heavily resource intensive, even for small businesses. Medium sized and large organisations generally employ fairly large IT teams to maintain and develop their IT infrastructure.

Response to IT infrastructure problems is generally reactive. If a problem occurs, the problem is then diagnosed and fixed. During the term (which may be a long time) of this reactive process, the IT infrastructure is either operating non-optimally, or not operating at all.

IT infrastructure monitoring platforms do exist, but generally use simple network monitoring protocol (SNMP) or other polling methods to gain information about an infrastructure. These methods are reactive and only alert operators when either a fault has already occurred or a variable is approaching a limit defined by the vendor of the equipment.

Real world applications show that infrastructures present unique operating characteristics when operating in a real-world environment. No two environments are the same, and what may be an acceptable limit in one environment could be an indication of ensuing disaster for another. Therefore, a manufacturer provided limit obtained through testing in a lab environment can only be used as a guide and not an identifier to future issues.

Resource intensive IT teams are therefore generally required to analyse and diagnose and fix any system problems for each organisations operating environment.

Another problem with the monitoring of the status of IT infrastructures, is that information on the operating parameters of the infrastructure is currently provided in very technical terminology. The obtaining of the information and the comprehension of it is therefore currently the provenance of skilled IT engineers. To obtain a view of the operation of IT infrastructure, an organisation's business manager must consult the skilled IT Engineers, often receiving a engineer-centric subjective view of the issue and how it may affect business.

### SUMMARY OF THE INVENTION

In accordance with a first aspect, the present invention provides a method of monitoring the status of an

IT Infrastructure, comprising the steps of:

determining a reference state of the infrastructure, the reference state comprising reference parameter data for a plurality of infrastructure parameters;

determining a current state of the infrastructure, the current state comprising current parameter data for the plurality of infrastructure parameters, and

determining a change in state of the infrastructure by comparing the current parameter data with the reference parameter data.

In an embodiment, the invention has the advantage that it captures a reference state of the IT infrastructure, which may be an ideal operating state for the infrastructure. A current state is then captured at discrete times, providing a historical trace of the operational state of the environment. If a problem occurs, or if the infrastructure is not operating optimally, it is quite likely that the change of state of the infrastructure, detected by this embodiment, is responsible for the problem.

Further, in this embodiment, a change in state can indicate that there may be a future problem, even where the problem has not yet occurred. Potential problems can therefore be anticipated and corrected before they occur.

In an embodiment, the parameter data can be any infrastructure data which may assist in determining the operational capability of the IT infrastructure data. It will generally, include variables deemed critical to maintain the environment, although it may be any data.

This embodiment has the advantage that the reference state provides a “picture” of a (preferably) ideal operating sate of the IT infrastructure. It is a simple matter to compare the reference state with the current state and see that there has been a change and identify that change. It does not require the usual forensic analysis of the IT infrastructure which would be applied by an IT engineering team. It merely requires a comparison between one state and another. It is therefore, in an embodiment, simple, quick and non-resource intensive to implement.

In an embodiment, the method comprises the further step of remediating the state of the infrastructure by implementing a remediation operation to return the state of the infrastructure to the reference state. In an embodiment, this remediation operation may be implemented automatically by a remediation process. In an embodiment, the method may comprise a plurality of remediation processes, one for each respective identified change in the operating state of the infrastructure.

In an embodiment, the method comprises a further step of analysing the change of state and determining whether a remediation operation may be implemented automatically. If so, then an appropriate remediation process will be applied. If not, an alert may be provided for a IT administrator, together with information about the change in state, to enable the IT administrator to take the appropriate action.

In an embodiment, the method comprises the further step of generating an IT infrastructure display, based on the current state of the infrastructure and any detected changes from the reference state, the IT infrastructure display depicting an operational state of the infrastructure.

In an embodiment, this may be provided on a display to a business administrator of the organisation, as a “business view”. That is, it will generally be a non-technical view providing information that can be appreciated by a business person who may not be skilled in IT. The business administrator therefore has the advantage of being able to see a current operational status of the organisation's IT infrastructure.

In an embodiment, the reference state of the IT infrastructure may be based on what is considered by the business as an ideal operating state to meet the business needs. That is, the reference state can be established based on business critical parameters, which may align with hardware/software functionality parameters, but not necessarily. What is important, in this embodiment, is that the infrastructure baseline operation delivers the functionality that is considered ideal to the business.

In an embodiment, the “business view” provided by the interface may be based on the business critical parameters, so the interface conveys whether or not the business operations required by the infrastructure are being delivered.

In accordance with a second aspect, the present invention provides a system for monitoring the status of an IT infrastructure, comprising a processor, memory and operating system supporting computer processes;

a capture process arranged to capture an operating state of the infrastructure, the capture process being arranged to determine a reference state of the infrastructure, the reference state comprising reference parameter data for a plurality of infrastructure parameters, and also being arranged to determine a current state of the infrastructure, the current state comprising current parameter data for the plurality of infrastructure parameters, and

a comparison process, arranged to can compare the current parameter data with the reference data, and determine a change in state of the infrastructure.

In accordance with a third aspect, the present invention provides a computer program, comprising instructions for controlling a computer to implement a method in accordance with the first aspect of the invention.

In accordance with a fourth aspect, the present invention provides a computer readable medium, providing a computer program in accordance with the third aspect of the invention.

In accordance with a fifth aspect, the present invention provides a data signal, comprising a computer program in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which:

FIG. 1 is a schematic block diagram of a system in accordance with an embodiment of the invention;

FIG. 2 is a block diagram of a computing apparatus which may be used to implement the system of FIG. 1;

FIG. 3 is a flow diagram illustrating a high level operation of an embodiment of the invention;

FIG. 4 is a flow diagram illustrating an example of a capture process in accordance with an embodiment;

FIG. 5 is a flow diagram illustrating operation of a rules engine in accordance with an embodiment of the present invention, and

FIGS. 6 to 9 are examples of IT infrastructure visualisations that may be delivered by embodiments of the present invention.

### DETAILED DESCRIPTION OF EMBODIMENTS

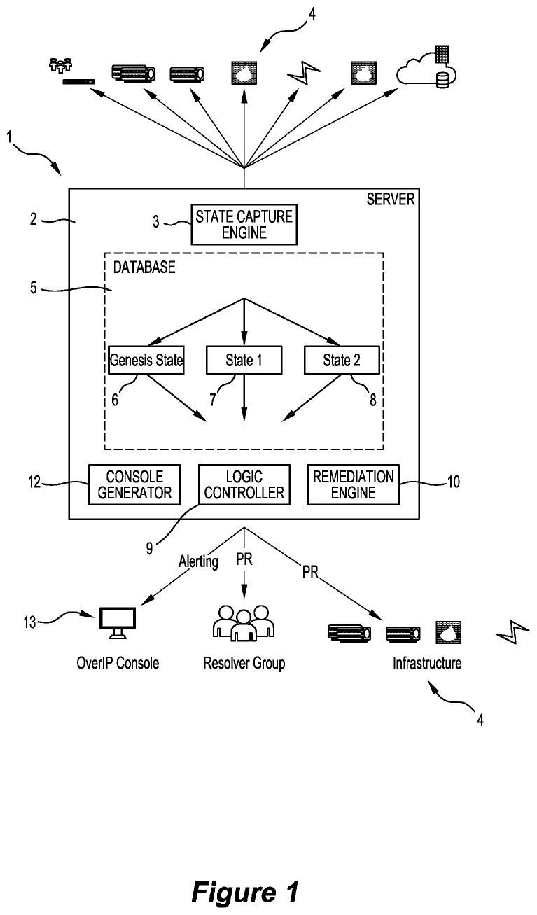

Referring to FIG. 1, a system in accordance with an embodiment of the present invention is generally designated by reference numeral 1. The system comprises a computing device 2, which may comprise a server computer, a network of computers or any computing system (the system may be supported by “cloud” architecture, for example). Computing system 2 comprises one or more processors, memory and an operating system supporting computer processes.

The system 1 comprises a capture process, in this example being implemented by a state capture engine 3, which may comprise appropriate hardware and software to implement the capture process. The state capture engine 3 is arranged to capture an operating state of IT infrastructure 4. IT infrastructure 4 may comprise any IT infrastructure. It may include computing systems, fire walls, networks, databases and generally any hardware/software architecture comprising an IT infrastructure.

The IT infrastructure 4 may support implementation of an organisation's business needs. The organisation may comprise distributed locations, so that the IT infrastructure may be disparately spread, countrywide or even worldwide. Alternatively, the IT infrastructure may be maintained at a single location.

The state capture engine 3 implements a capture process to capture an operating state of the infrastructure 4. In this example, a reference state of the infrastructure is captured, comprising reference parameter data for a plurality of infrastructure parameters. The reference parameter data is obtained, in this example, during an ideal operating state of the infrastructure. This “genesis” state forms a reference for the optimal operation of the infrastructure 4.

The state capture engine 3 is also arranged to implement the capture process at further discrete times to capture current operating states of the infrastructure, in the form of current parameter data for the plurality of infrastructure parameters.

The system 1 also comprises a database 5, which stores the genesis state 6 and the periodically captured current state 7, 8 and so on. The database may be implemented by any known database architecture.

The system 1 in this example also comprises a logic controller 9, implemented by appropriate hardware and software, which implements a comparison process arranged to compare the current parameter data with the reference parameter data to determine any change in the state of the infrastructure.

In this example, the logic controller also implements a rules engine, which can determine action to be taken based on any change in state of the infrastructure detected. In an embodiment, a remediation engine 10 may be arranged to automatically implement computing processes to remediate the infrastructure 4 by, for example, adjusting it back to the genesis state 6. This may fix any problem or potential problem with the infrastructure 4. The remediation engine may implement many different types of remediation processes automatically.

If the remediation engine 10 does not operate a remediation process that will adjust the state of the infrastructure detected to enable the infrastructure to operate, the rules engine may escalate by creating a message to send to a review group and/or IT administrator and/or business administrator.

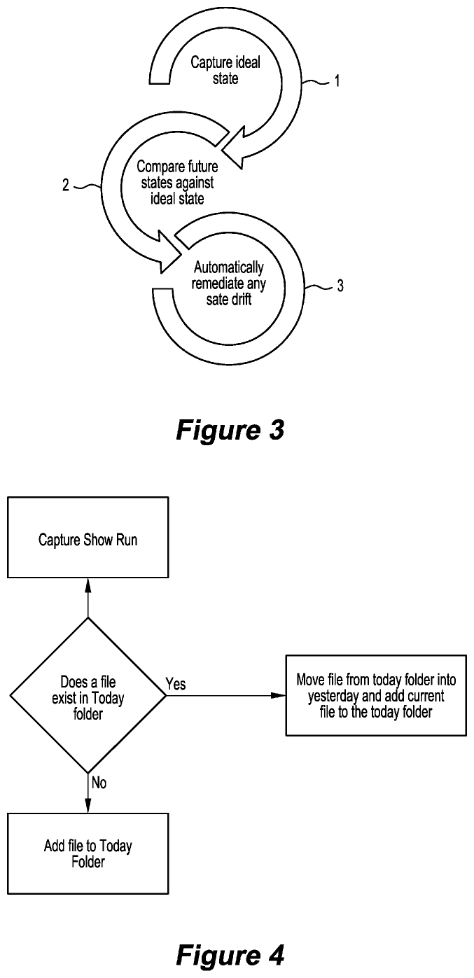

Referring to FIG. 3, the system 1 operates to capture the ideal state of an IT infrastructure (step 1). It compares captured future states of the infrastructure against the ideal state (step 2). It then implements automatic remediation action, or alternatively, advises administrators to take action (step 3).

Referring again to FIG. 1, in this embodiment, a console generator 12, comprising appropriate hardware and software, is arranged to generate an IT infrastructure status display, based on the current state of the infrastructure, and deliver this to an administrator display or console 13. This provides an administrator with an operating view of the IT infrastructure status for their organisation.

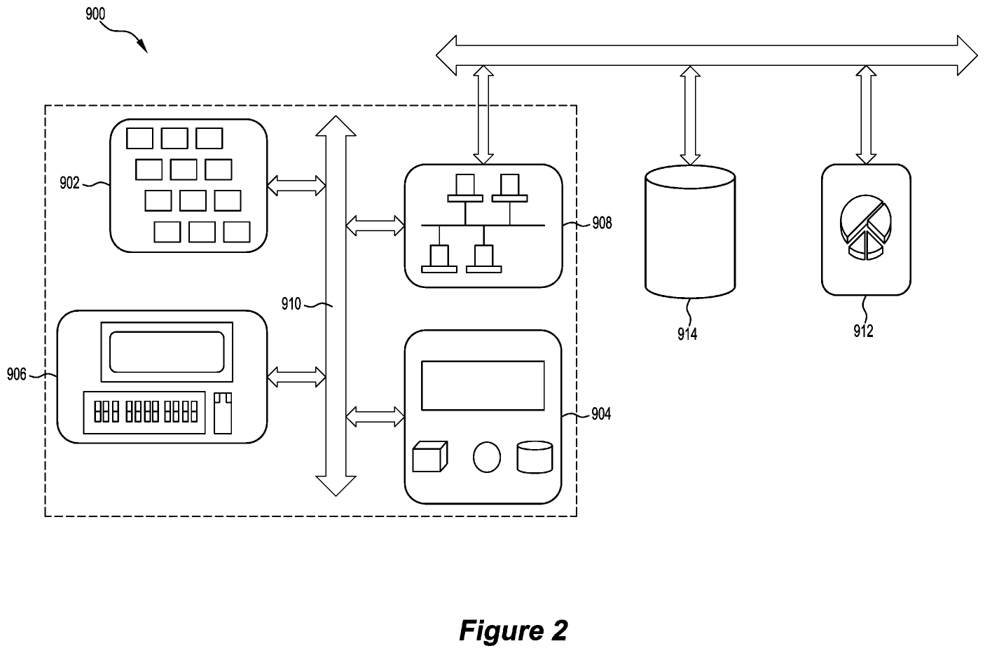

An example of a computing apparatus which may be used to implement the computing apparatus 2 of the system 1, will now be given with reference to FIG. 2.

FIG. 2 shows a schematic diagram of components of a computer system (900) which may implement the computing apparatus 2. Computer system 900 may be a high performance machine, such as a super computer, a desktop desktop work station or a personal computer, or may be a portable computer such as a laptop or a notebook or may be a distributed computing array or a computer cluster or a network cluster of computers. In this example, the server architecture and database architecture is implemented by hardware and software supported in the “Cloud”. The system 1 may be provided as software/hardware as a service to maintain an organisation's IT infrastructure, or may be owned by the organisation.

The computer system 900 comprises a suitable operating system and appropriate software for implementation of the various processes operated by the system 1.

The computing apparatus 900 comprises one or more data processing units (CPUs) 902; memory 904, which may include volatile or non-volatile memory, such as various types of RAM memories, magnetic disks, optical disks and solid state memories; a user interface 906 which may comprise a monitor, keyboard, mouse and/or touch-screen display, may enable access by an administrator of the system 3. A network communication interface 908 for communicating with other computers and devices is also provided, and one or more communication buses 910 for interconnecting the different parts of the system 900.

The computer system 900 may access data stored in a remote database 914 via network interface 908 (the database 914 may correspond to the database 6 shown in FIG. 1). Database 914 may be a distributed database.

A computing apparatus for implementing embodiments of the invention is not limited to the computer apparatus described above. Any computer system architecture may be utilised, such as standalone computers, networked computers, dedicated computing devices, handheld devices or any device capable of processing information in accordance with embodiments of the present invention. The architecture may comprise client/service architecture, or any other architecture.

The computing system is provided with an operating system and various computer processes to implement functionality. The computer processes may be implemented as separate modules, which may share common foundations such as routines and sub-routines. The computer processes may be implemented in any suitable way and are not limited to separate modules. Any software/hardware architecture that implements the functionality may be utilised.

System 1 will now be described in more detail with reference to an example. The state capture process is arranged to capture the operating state of the IT infrastructure. In this embodiment, the system 1 is arranged to monitor the IT infrastructure by the capture process using SecureShell (SSH) or requests sent to an infrastructure API. The reference parameter data captured relates to information important for operation of the IT infrastructure environment. For example, consider a Cisco™ data network environment, the information could include:
The running configuration “show run”
The interface status “show ip int brief”
The routing information base “show ip route”
The software and firmware version “show version”

Additional information could be captured if deemed interesting or critical to an environment. The information is captured through SSH or an API. An automation tool such as Ansible or infrastructure controller is used to automate the capture of the necessary information. Once the information is captured, it is stored in data store 5 ready for the logic controller 9 to compare it with the ideal state. In this embodiment, a general database 5 is used to store the parameter data. In an alternative embodiment, blockchain technology is implemented to store the captured reference data in a unique block. Either of these storage systems may be used (or any other convenient storage system).

Below is an example of a script written in yaml that will collect state information off network infrastructure. State can comprise a multitude of checks. For this example, we are only interested in state changes to a configuration file which can be seen in the output of a “show run” relating to a CiscoTM data network.

- name: show run
ios_command:

commands:

- show run

provider:“{{ provider }}”

```
  register: shrun
- name: check if old shrun exists
  stat: path={{ shrun_dir }}/today/{{ inventory_hostname }}-shrun
  register: shrun_exists
- name: Move shrun to old folder if it exists
  command: mv {{ shrun_dir }}/today/{{ inventory_hostname }}-shrun
  {{ shrun_dir }}/yesterday/{{
inventory_hostname }}-shrun
  when: shrun_exists.stat.exists
- name: write show version to a file
  delegate_to: localhost
  copy: dest=“{{ shrun_dir }}/today/{{ inventory_hostname }}-shrun”
  content=“{{ shrun.stdout[0]
}}”
```

In this example the state is stored in a local file system. The script will capture the outputs of the show command and store them in a file called ‘Today’. If today is occupied by another file, it will copy the contents of ‘today’ to tomorrow' and install the new file in ‘Today’. A diff will run between the contents in both folders. See FIG. 4, which is a flow diagram illustrating the process.

To assess how the files stored in the folders differ, the logic controller 4 runs a script to determine what has changed on the infrastructure. This is written in python and the output of comparing files in folder ‘today’ and folder ‘tomorrow’ will look like:

[+] ip host AAppserver X.X.X.X
[+] tcp eq 8089
[+] udp eq 9997
[+] permit object-group SVC_Splunk object-group NET Splunk Client
[+] Current configuration : 39135 bytes
[+] object-group network NET_Retail_Dashboard_Svrs
[+] ! NVRAM config last updated at 22:16:49 AEDT Sun Dec 3 2017
by Jsmith
[+] tcp eq 9997
[+] object-group service SVC_Splunk
[+] object-group network NET_Splunk_Clients
[+] host X.X.X.X
[+] host Y.Y.Y.Y
[+] permit object-group SVC_Splunk object-group NET Splunk Client
object-group Svrs
[+] ! Last configuration change at 22:12:49 AEDT Sun Dec 3 2017
by Jsmith
[+] udp eq 8089
[−] Current configuration : 38548 bytes
[−] ! Last configuration change at 21:56:44 AEDT Sun Nov 26 2017
by Jsmith
[−] ! NVRAM config last updated at 13:18:29 AEDT Mon Nov 27 2017
by Jsmith

The + and − indicating what was added or removed to the initial capture. The comparison therefore gives a “picture” of what has changed between the current state and the reference state. The logic controller 9 implements a rules engine, which executes actions based on the detected change.

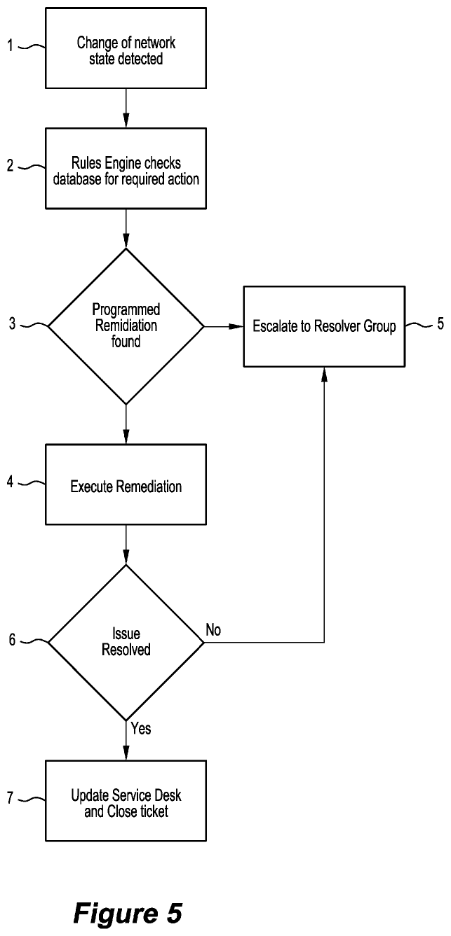

Actions will range from programmed remediation, where a script will be run by the remediation engine 10 to remediate an identified issue or escalate to a resolver group in the event no remediation is found. An example of a network remediation workflow is given in FIG. 5:

At step 1, the change of network state is detected.

The rules engine then checks the database 5 for required action (step 2).

If a programmed remediation is found, this is executed (steps 3 and 4).

If no program remediation is found, the issue is escalated to the resolver group (step 5) and information on the changed networks status provided to the resolver group to assist them in resolving the issue.

The issue is resolved (step 6) and an administrator is advised (step 7).

Embodiments of this invention may be implemented to monitor and maintain any IT infrastructure. A capture process may comprise any software/hardware for capturing the required reference parameter data and current parameter data of the infrastructure. Because a change in the state of the infrastructure is looked for, and a return to the “ideal” state can be implemented, this may vastly reduce the difficulty and time required to diagnose and fix IT infrastructure problems. Note that, periodically, the reference state may be adjusted. Upgrades in equipment and software, for example, may result in a new reference state. The system of the present invention merely updates the reference parameter data for the new reference state and then continues to compare current state against the new reference state. In some embodiments, monitoring the current state and comparing against a referenced state may detect operational changes in the infrastructure that may lead to upgrading of the infrastructure (and changes to the reference state).

Many automated remediation processes may be implemented. These may be continually developed as the system operates.

The system may liaise with internal IT engineers or may support service desk providers and other IT consultants.

In embodiments, the reference, or genesis state may be determined based upon the business needs of a business. The business may determine an ideal operating state for it's infrastructure, which provides the ideal business outcome. The reference state can therefore be “designed” based on the ideal business outcomes required to be implemented by the infrastructure. In implementing the method and system, the business can therefore be initially queried to be determine the ideal business outcomes delivered by the infrastructure, and therefore the ideal state (genesis state) of the infrastructure. The method and system of embodiments then track departures from this ideal infrastructure operation, as discussed above.

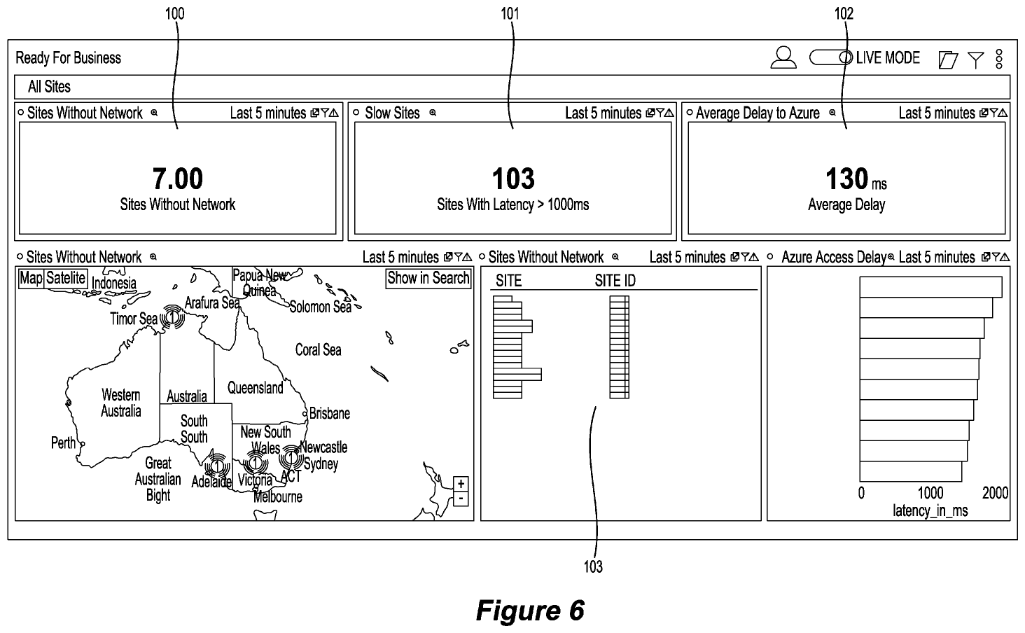

Referring again to FIG. 1, the console generator 12 is arranged to generate an IT infrastructure display status, which may appear on any display, in this example on the console 13. Examples of displays which might be provided for the status of IT infrastructure are given in FIGS. 6 to 9. What is to be displayed, may be determined, in embodiments, based on the business needs of the business. What does the business administrator wish to see and what do they consider to be business critical? For example, the dashboard shown in FIG. 6 has been designed to display a number of infrastructure parameters. These include “sites without a network” 100; “slow sites” 101; information on “average delay” 102; sites without network 103 and other features as shown.

Multiple types of dashboards can be designed, depending on what the business wishes to be aware of.

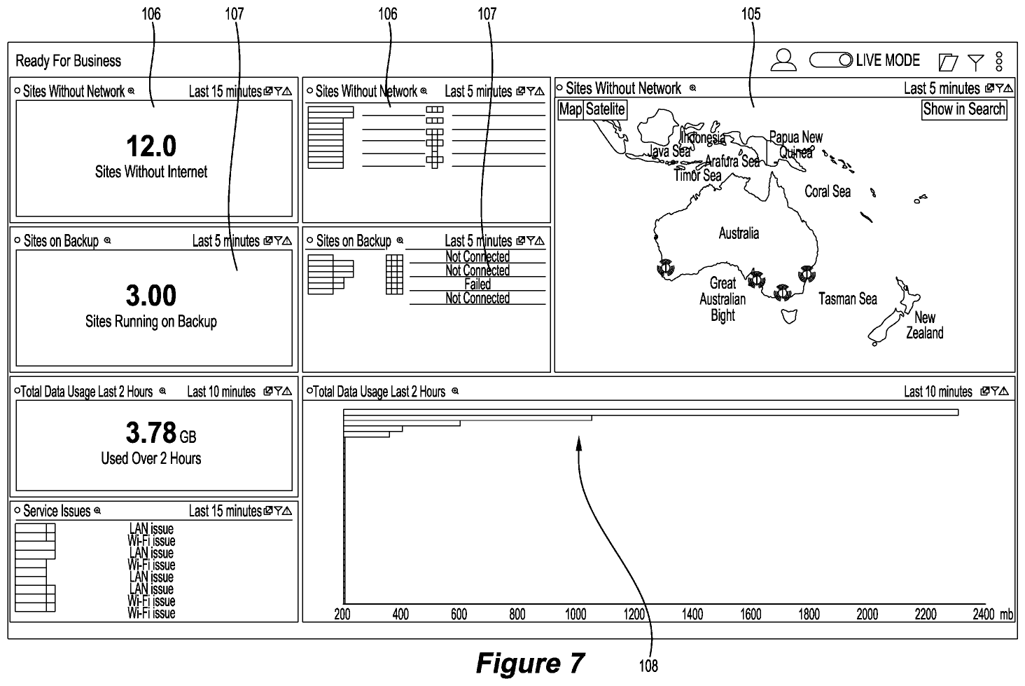

FIG. 7 shows a dashboard giving slightly different information from FIG. 6;

Sites without internet 105, 106, sites on backup 107; data usage 108 and other information.

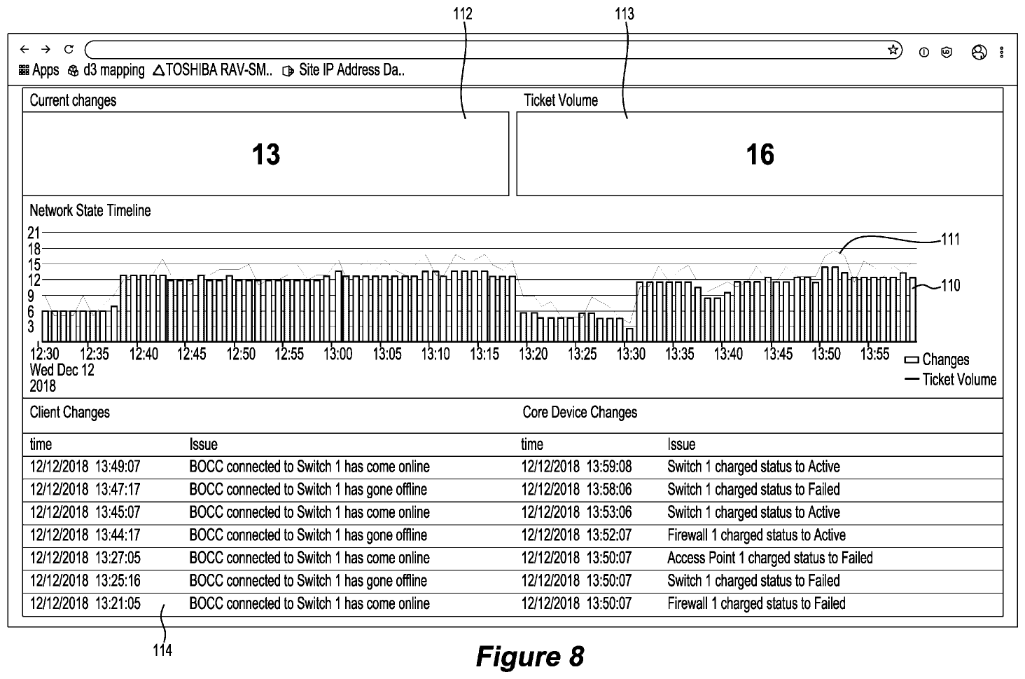

FIG. 8 shows a dashboard that gives more of a detailed view of what is happening with the infrastructure. Plot 110 shows bars which indicate the number of changes that occurring in the infrastructure from the ideal state, against time 110. Overlaid is a plot 111 which indicates the number of “tickets” (queries) being received from users or others regarding operation of the infrastructure. Note that the number of tickets tracks the changes quite well. The current number of changes 112 and ticket volume 113 are shown above.

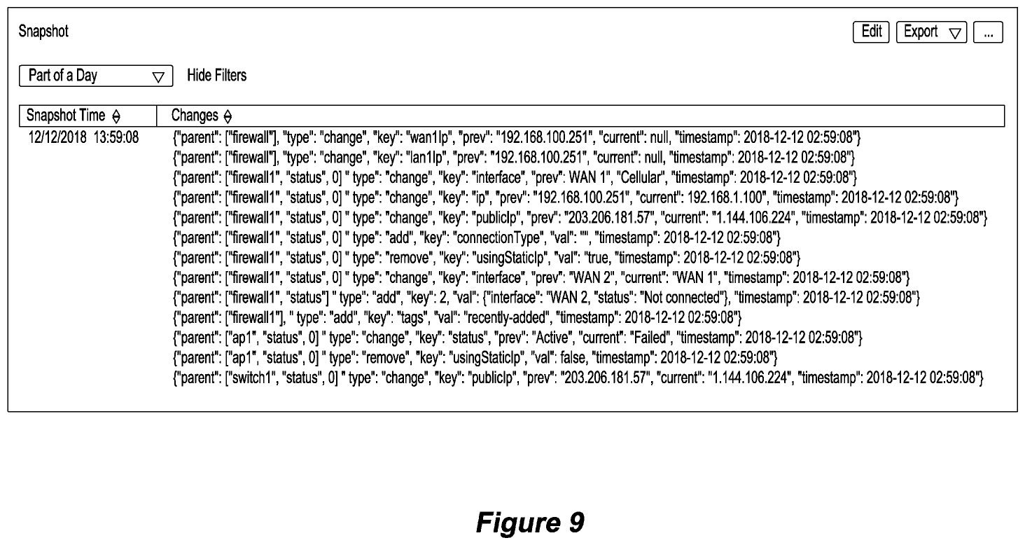

The information below the plot shows actual changes to devices (e.g. the Back Office PC) 114 and changes to core devices 115 (such as Network Access Point). FIG. 9 shows a “Snapshot” display which drills further down into the type of changes occurring device details.

Essentially any display can be designed, depending upon the business needs. The dashboards provide an overlay of business logic to the changes to the infrastructure being monitored by the embodiment.

The mediation process may also be designed depending on big business needs. A number of remediation processes may be selected as automated, and others may require or be designed to require escalation to IT personnel.

These “at a glance” consuls enable business administrators to monitor status of their IT infrastructure.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of monitoring the status of an IT Infrastructure, comprising the steps of:
determining a reference state of the infrastructure, the reference state comprising reference parameter data for a plurality of infrastructure parameters;
determining a current state of the infrastructure, the current state comprising current parameter data for the plurality of infrastructure parameters, and
determining a change in state of the infrastructure by comparing the current parameter data with the reference parameter data.

2. A method in accordance with claim 1, comprising the step of remediating the state of the infrastructure by implementing a remediation operation to return the state of the infrastructure to the reference state.

3. A method in accordance with claim 2, wherein the remediation operation is implemented automatically by a remediator process.

4. A method in accordance with claim 2, comprising the further step of analyzing the change in state and determining whether the remediation operation may be implemented automatically.

5. A method in accordance with claim 4, wherein, if it is determined that the remediation operation cannot be implemented automatically, the method comprises a step of generating a message regarding the change of state and transmitting the message to an administrator system.

6. A method in accordance with claim 1, comprising the step of generating an IT Infrastructure status display, based on the current state of the infrastructure, the IT infrastructure display depicting an operational state of the infrastructure.

7. A method in accordance with claim 1, wherein the steps of determining a reference state of the infrastructure, comprises determining an operational state of the infrastructure for optimum business outcomes, and designating that operating state as the reference state.

8. A system for monitoring the status of an IT infrastructure, comprising a processor, memory and operating system supporting computer processes;
a capture process arranged to capture an operating state of the infrastructure, the capture process being arranged to determine a reference state of the infrastructure, the reference state comprising reference parameter data for a plurality of infrastructure parameters, and also being arranged to determine a current state of the infrastructure, the current state comprising current parameter data for the plurality of infrastructure parameters, and
a comparison process, arranged to compare the current parameter data with the reference data, and determine a change in state of the infrastructure.

9. A system in accordance with claim 8, further comprising a remediation process arranged to remediate the state of the infrastructure by implementing a remediation operation to return the state of the infrastructure to the reference state.

10. A system in accordance with claim 9, further comprising an analysis process arranged to analyze the change in state and determine whether the remediation process may be implemented.

11. A system in accordance with claim 10, wherein, if the analysis process determines that the remediation process cannot be implemented, the system is arranged to generate a message regarding a change of state and transmit the message to an administrator system.

12. A system in accordance with claim 11, comprising an interface process, arranged to generate an IT infrastructure status display, based on the current state of the infrastructure, the IT infrastructure display depicting an operational state of the infrastructure.

13. A computer program, comprising instructions for controlling a computer to implement a method in accordance with claims 1.

14. A computer readable medium, providing a computer program in accordance with claim 13.

15. A data signal, comprising a computer program in accordance with claim 13.

16. A method in accordance with claim 3, comprising the further step of analyzing the change in state and determining whether the remediation operation may be implemented automatically.

17. A method in accordance with claim 16, wherein, if it is determined that the remediation operation cannot be implemented automatically, the method comprises a step of generating a message regarding the change of state and transmitting the message to an administrator system.

18. A method in accordance with claim 4, comprising the step of generating an IT Infrastructure status display, based on the current state of the infrastructure, the IT infrastructure display depicting an operational state of the infrastructure.

19. A method in accordance with claim 18, wherein the steps of determining a reference state of the infrastructure, comprises determining an operational state of the infrastructure for optimum business outcomes, and designating that operating state as the reference state.

20. A system in accordance with claim 8, comprising an interface process, arranged to generate an IT infrastructure status display, based on the current state of the infrastructure, the IT infrastructure display depicting an operational state of the infrastructure.
